(19) United States
(12) Patent Application Publication
(10) Pub. No.: US 2004/0143846 A1
(43) Pub. Date: Jul. 22, 2004

(54) User interface, method and system for accessing digital entertainment or similar content

(76) Inventors: Robert Zeps, Rancho Santa Fe, CA (US); Pertti Visuri, Fallbrook, CA (US)

Correspondence Address: IRELL & MANELLA LLP, Suite 900, 1800 Avenue of the Stars, Los Angeles, CA, 90067, US

(21) Appl. No.: 10/633,115

(22) Filed: Aug. 1, 2003

Related U.S. Application Data
(60) Provisional application No. 60/400,581, filed on Aug. 1, 2002.

(51) Int. Cl. H04N 7/173; H04N 5/445; G06F 3/00; G06F 13/00

(52) U.S. Cl. 725/61; 725/86; 725/37; 725/38

(57) ABSTRACT

A method and system are disclosed to access different forms of audio, video or other digital entertainment content, for example, content that is stored on a home PC or in audio, video or other storage devices, or content that is made available through a transmission, streaming or download. A method and system according to the present disclosure will facilitate access to this content and its distribution to appropriate audio, video or other digital devices for playback. The method and system allows end users to access their content without having to physically go to the device or system that stores or first receives the content. They can have it delivered to wherever they would like to listen, view or otherwise enjoy or consume the content. It further allows for a very intuitive, visual and convenient way to organize and manage digital content.

### RELATED APPLICATIONS

This application claims the priority of U.S. provisional patent application Serial No. 60/400,581 filed Aug. 1, 2002.

### BACKGROUND OF THE INVENTION

1. Field of the Invention

This invention relates to network user interfaces, and more specifically to network user interfaces for accessing and performing digital content.

2. Description of the Prior Art

The advances in storage and communication of digital content, including audio, video and other multimedia content has made it practical to store large amounts of audio recordings, for example music performances, on personal computers. Other devices have also been introduced for the purposes of storing digital content, for example digital video recorders such as TIVO and several music “jukebox” devices that have been specifically designed for music storage. In addition, a growing number of radio stations are available in the form of digital audio streams. Thousands of radio stations can already be accessed over the Internet. It is anticipated that similar proliferation of content will take place pertaining to digital video content and eventually to other forms of content as well. It certainly has already taken place regarding text and image content.

The growing amount of audio or other media files on home PC systems and the availability of other content has created a problem regarding convenient and intuitive ways to access particular pieces of the content. Another related issue, is the equipment that is best suited for accessing and managing the content is not the same equipment that is best for rendering it. In addition, the two kinds of systems typically are not even located in the same space in people's homes. The Personal computer is best for accessing and managing the growing variety of digital content, and the entertainment center, often including a hi-fi audio player and/or a television, are designed and suited for listening or viewing audio and video content. The issue of organizing the content and conveniently and intuitively selecting the particular elements of content from a large collection of possible choices remains unsolved.

There are several systems that let the user play digitally stored music using the computer. For example, digital music management programs such as MusicMatch and others provide access to the content in the form of a list of recordings retrieved from the programs database of available content and presented on the computer screen. However this list is only viewable at the PC, or by using another expensive display device, such as a pocket PC that would be connected to the database. It also has the drawback of requiring the user to be comfortable with a computer based user interface, and does not correspond to a method of sorting music or selecting content that most users are used to all their life, namely handling the actual vinyl record, CD, video tape or DVD that contains the content.

The way that typical consumers of music, for example, have become used to finding and identifying the music that appeals to them is not by the alphanumeric name or characterization of the recording, (was it Greatest Hits 1 from 1976 or the Greatest Hits 2 from 1931?). It is the album cover graphic that has become the clue that people with extensive collections of recordings use to keep the content organized in their mind. This graphical metaphor and the physical handling of the recordings is what make consumers of music comfortable in managing their collections. The PC screen based list management of music has typically only found acceptance among college students and others who are particularly familiar with computers. In addition, the success that this method has enjoyed has been with usually free downloaded music files for which there has not been any alternative method of access. In addition college students usually just have one room as their living space so the issue of wanting to enjoy the music in a different space than the one where the personal computer is located has really not been important for this user group. Downloaded or computer stored music has not found users in settings where specialized hi-fi equipment is typically used for listening to music. However, it is these settings that are typical for users of content that have the income levels that make them interesting targets for vendors of audio content.

Another dimension to the problem is that in many cases the end user wishes to select a number of content elements to be performed in a sequence. This function is available in most multi-CD player devices. They often allow for programming a sequence of music performances from the content. However, the user interface for these functions is typically very cumbersome, and since the programming function is only relevant for the time the CD's in the system tray stay in their place, the effort to do the programming is typically too high compared with the reward of enjoying the relatively small selection of music in a particular order. The PC based music management programs that were mentioned above allow the users to build so-called playlists. These are selections of several performances from the database interface. This is a step in a good direction in meeting the consumer demand. However, accessing these combination selections requires the user to go to the PC and use the computer interface to start the playing.

Similar issues can be seen to arise regarding access to other types of content, besides music recordings stored on a home PC. Consequently, a need exists to provide a better user interface for accessing specific digital content from a source that contains many possible choices.

### SUMMARY OF THE INVENTION

In a first aspect, a method of accessing digital content is provided which makes available to a user a token having a characteristic recognizable by the user as associated with the digital content, the token also including a machine readable characteristic and automatically presenting the digital content to the user in response to the user's selection of the token.

The token characteristic may be an image or shape. The digital content may reside on a server device and may include audio and/or video content. The digital content may reside, or be primarily accessed by, a device that is not located where the digital content is presented.

In another aspect, a method of accessing digital audio content over a wireless network is provided by making available a token having an image representing the performer(s) and a particular performance of specific digital content and including a machine readable code, automatically identifying the code in response to a user's selection of the token, transmitting a digital stream over a wireless local area network, the digital stream includes the specific digital content corresponding to the token, receiving the digital stream, converting the digital stream to a standard audio input signal, and performing the digital audio on a local entertainment center.

These and other features and advantages of this invention will become further apparent from the detailed description and accompanying figures that follow. In the figures and description, numerals indicate the various features of the invention, like numerals referring to like features throughout both the drawings and the description.

### BRIEF DESCRIPTION OF THE DRAWINGS

FIG. 1 is a block diagram of a basic workflow according to the present disclosure.

FIG. 1A is a system block diagram according to the present disclosure.

FIG. 2 is high level use case diagram according to the present disclosure.

FIG. 3 is a decomposed use case diagram for a register target step according to the present disclosure.

FIG. 4 is a decomposed use case diagram for determining action step according to the present disclosure.

FIG. 5 is a decomposed use case diagram for responding to a message step according to the present disclosure.

FIG. 6 is a decomposed use case diagram for administering system stop according to the present disclosure.

FIG. 7 is a logical component block diagram according to the present disclosure.

FIG. 8 is a high level diagram of a Java/J2EE component framework according to the present disclosure.

FIG. 9 is a block diagram of component relationships in a system according to the present disclosure.

FIG. 10 is a block diagram of basic communication class structure according to the present disclosure.

FIG. 11 is a block diagram of a database layout according to the present disclosure.

FIG. 12 is a block diagram of a low end system configuration according to the present disclosure.

FIG. 13 is block diagram of a high end system configuration according to the present disclosure.

FIG. 14 is a flow block diagram for a component of the present system.

FIG. 15 is a device manager class block diagram according to the present disclosure.

FIG. 16 is a device manager sequence block diagram according to the present disclosure.

FIG. 17 is an event source manager class block diagram according to the present disclosure.

FIG. 18 is an event source manager sequence block diagram according to the present disclosure.

FIG. 19 is a monitor and action commander class block diagram according to the present disclosure.

FIG. 20 is an action commander class block diagram according to the present disclosure.

FIG. 21 is an action commander sequence block diagram according to the present disclosure.

FIG. 22 is a session facade class block diagram according to the present disclosure.

FIG. 23 is a service activator class block diagram according to the present disclosure.

FIG. 24 is a session facade sequence block diagram according to the present disclosure.

FIG. 25 is a service activator sequence block diagram according to the present disclosure.

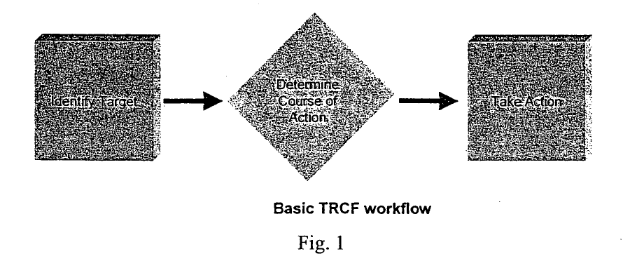

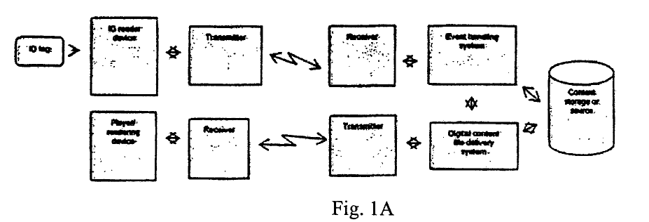

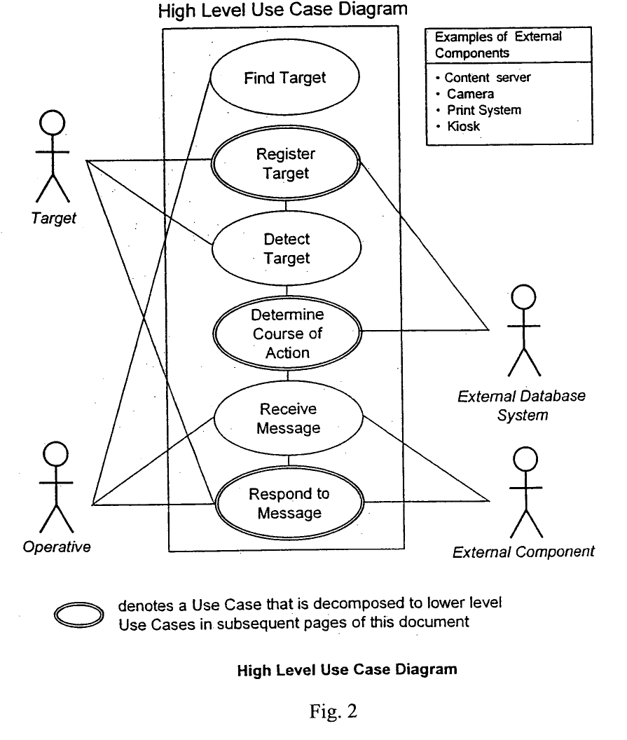

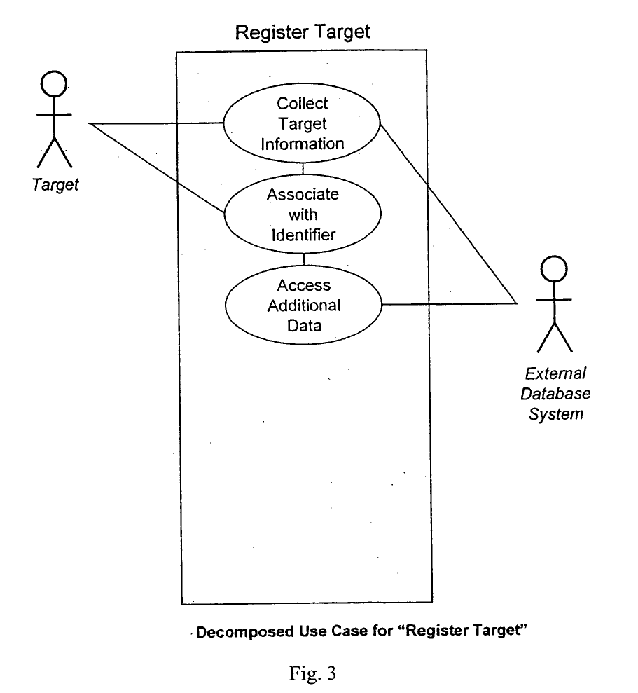

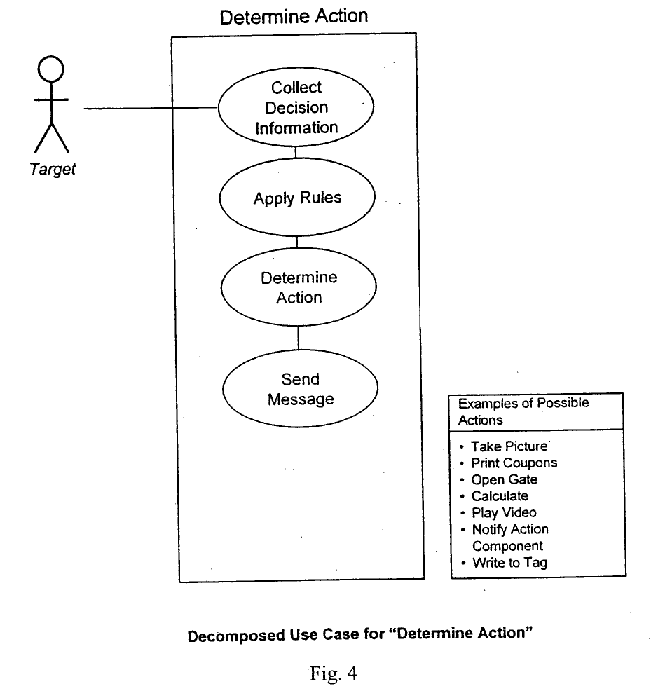

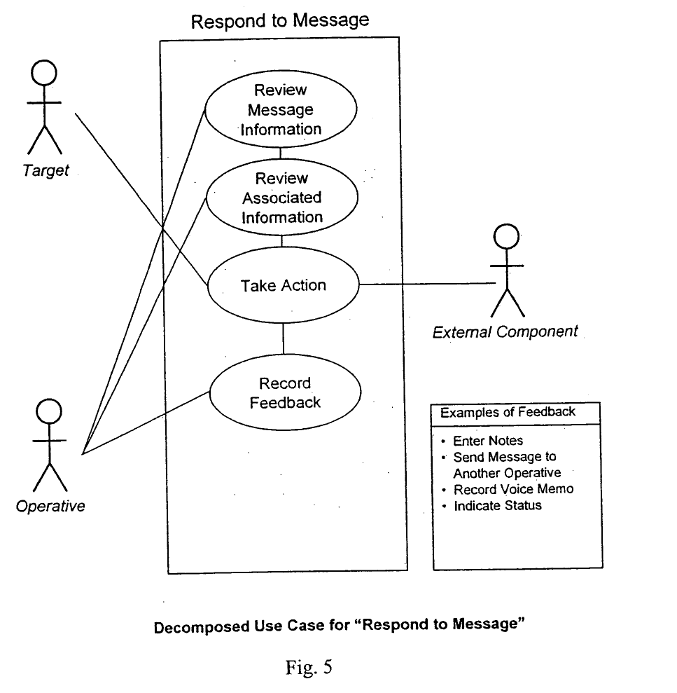

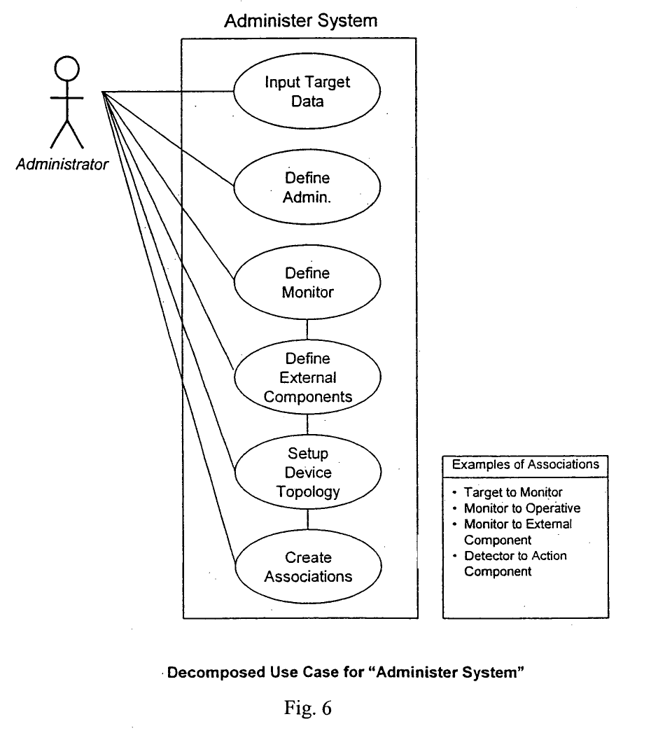

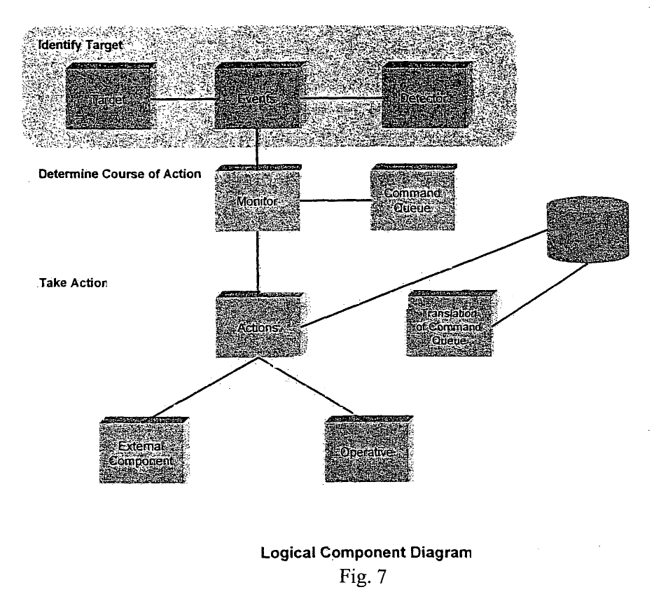

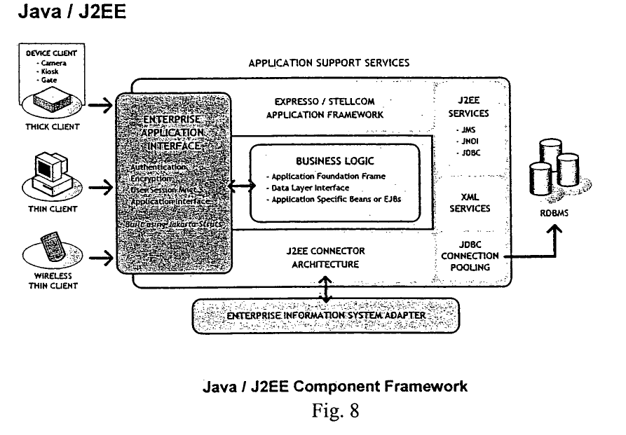

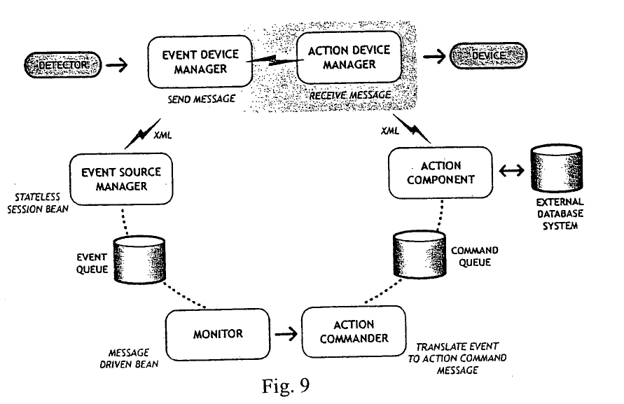

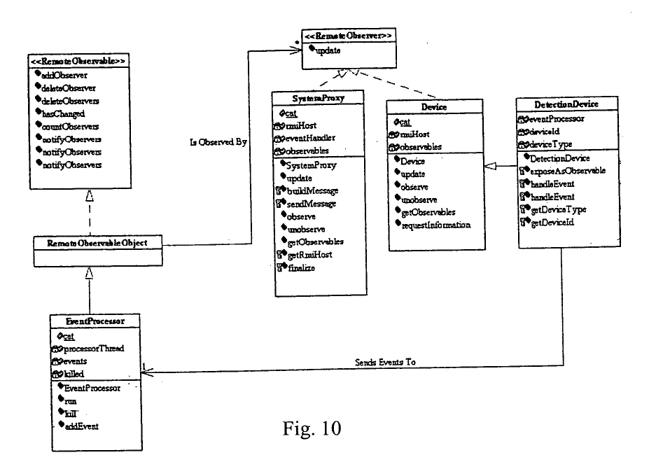

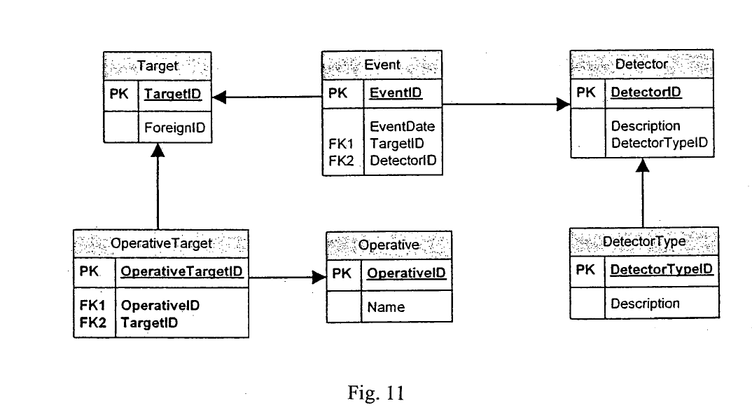

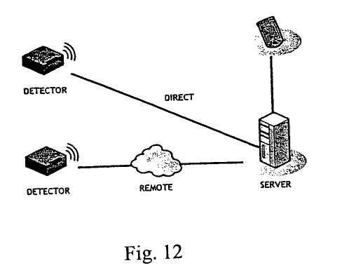

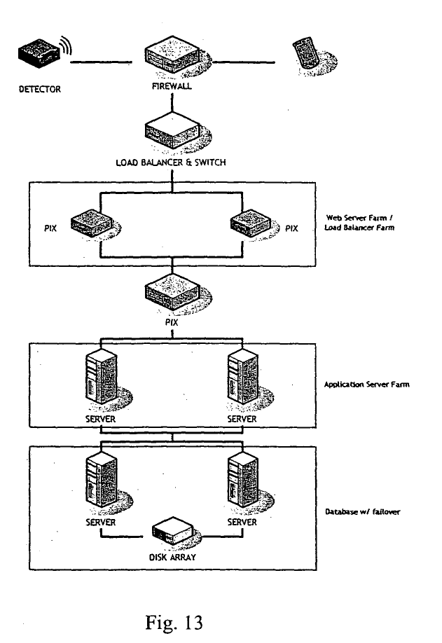

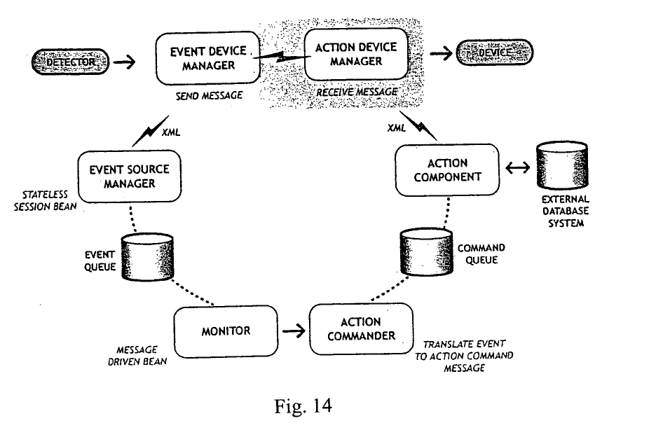

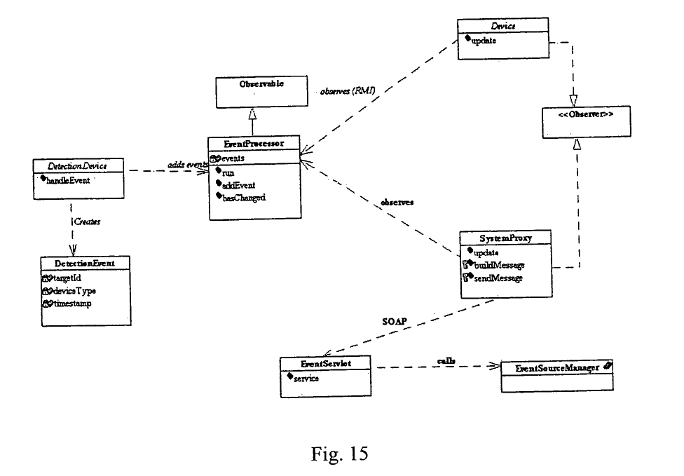

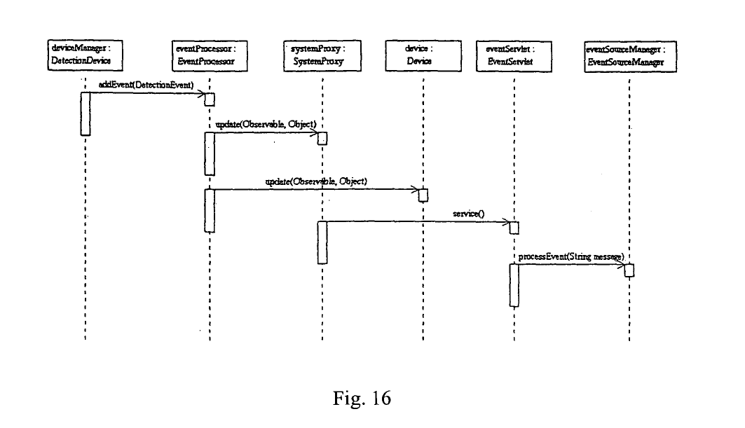

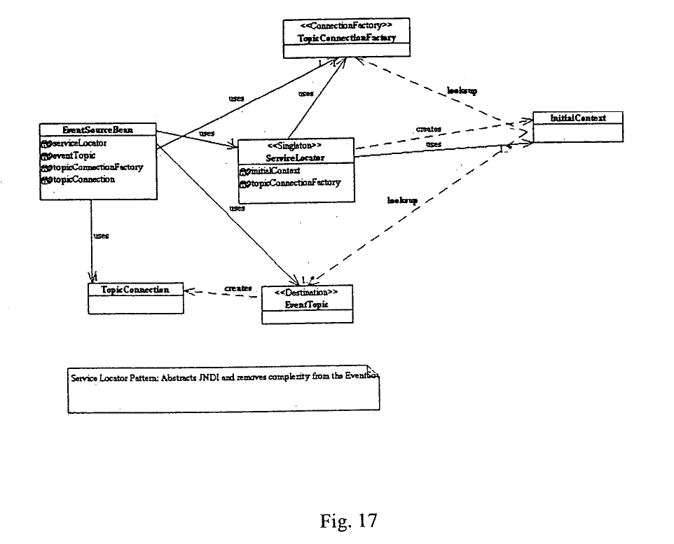

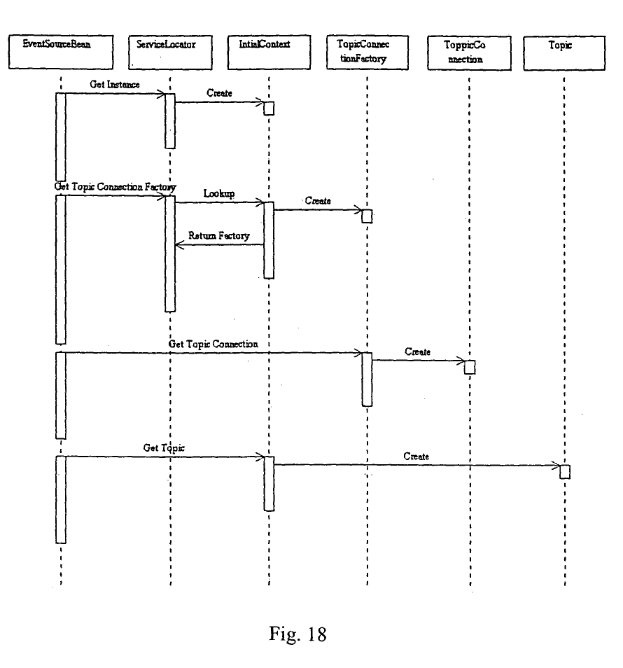

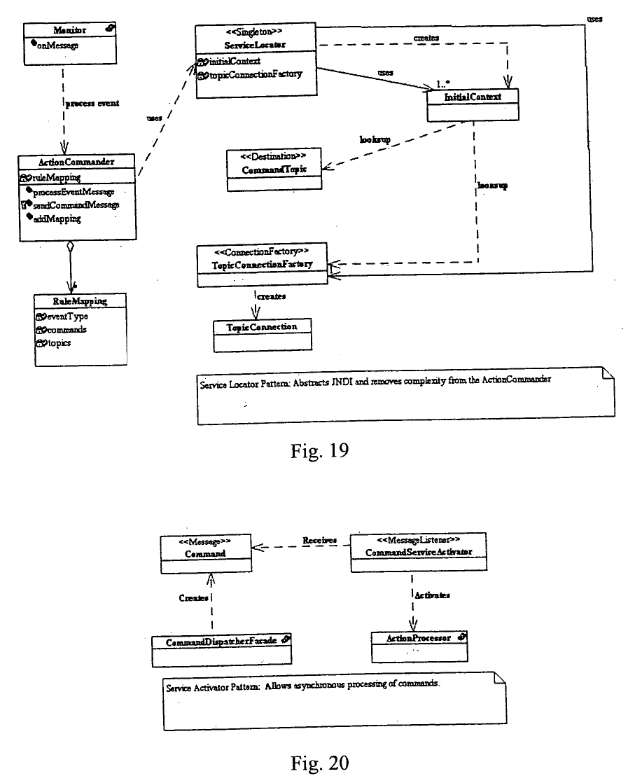

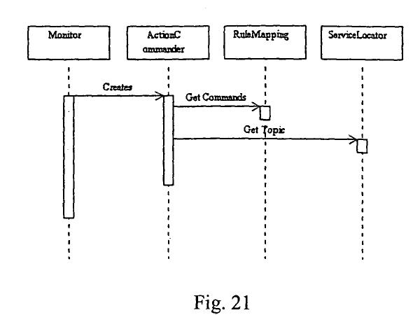

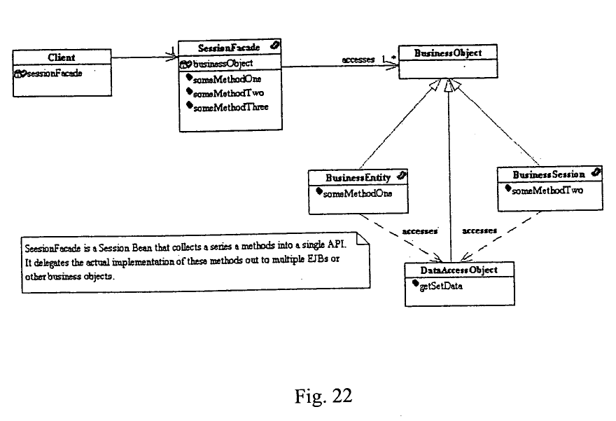

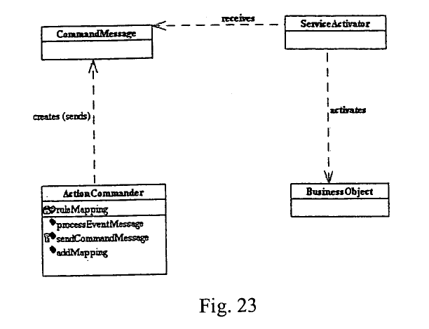

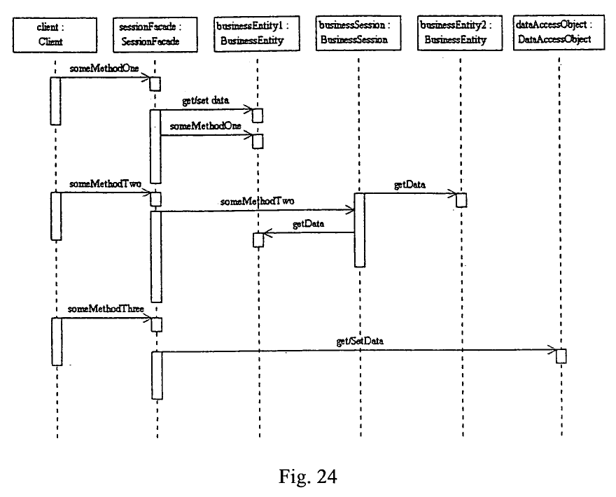

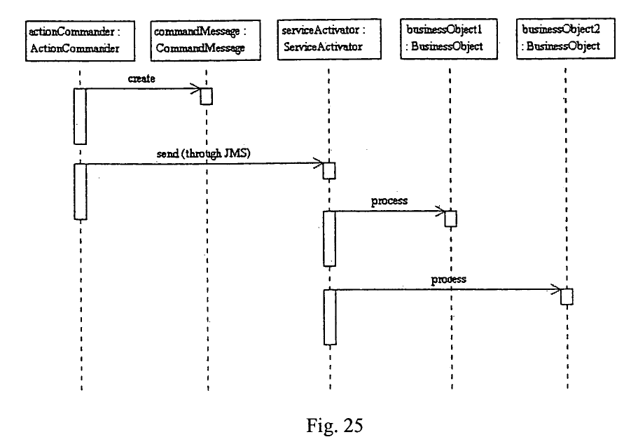

### DETAILED DESCRIPTION OF THE PREFERRED EMBODIMENT(S)

The audio, video or other digital content file collection of many end users often reach into the hundreds or thousands, if each track on music recordings is counted separately. An individual's ability to recall every performance by just a name is quite limited. The visual clue of the album cover or CD sleeve is the way consumers of music content have grown used to identifying a specific piece of content and may be used to quickly sort through a collection and access that content quickly and effortlessly.

The present disclosure addresses the emerging need to access, increasingly large collections of audio, video or other digital content that is stored on home PCs, large capacity CD players, set top box devices, or on other digital storage mediums used in entertainment systems. It also applies to accessing content that may be streamed over the internet, delivered over cable TV network systems, or be available for downloading on servers or other storage devices. The disclosed methods permit access to audio, video or other digital files by using a small physical representation of the audio, video or other digital file, album, movie or other content item, or a collection of content items. The representation has a shape or an image or other visual or tactile clues to remind the user which content is associated with it. It also has a characteristic that enables an automatic system to identify it. This characteristic can be an embedded RFID tag, a bar code, a magnetic stripe or other automatically readable code. The disclosed method may use a computer based system to respond to the detection of the item by accessing the associated piece of digital content from storage and transmitting it to a player device. The disclosed system may include a standard REID reader, a standard wireless network for presenting the detected ID and a computer program that responds to the detection event and accesses the content and transmits it to the payer device.

The disclosed method and system may use some or all of the following components:

Standard hard drives, DVD's or other storage media found in many home PCs and in specialized entertainment storage devices; Network routing or modem devices, such as modems, DSL connections, satellite transmissions, or cable TV set top and similar systems for delivering and storing digital content.

Radio Frequency Identification (RFID) tag technologies; Bar code reader devices, magnetic stripe readers or other identification technologies used for physical objects.

Suitable, durable medium, such as cardboard or plastic for embedding RFID tags, printing bar codes, or embedding magnetic stripe or other identification token, as well as for printing artwork or other images.

RFID readers/interrogators that detect the presence of the tags, or bar code or magnetic stripe or other ID tag reader devices.

A home networking method, whether it is a traditional wired system or a wireless networking protocol based method.

Standard wireless IP protocols such as 802.11, home RF or Bluetooth to facilitate communication between wireless devices if required; or infrared based communications method.

Interface software to communicate between ID tag identification and backend database, or delivery system for content, for example software.

There are a number of ways where one particular token can represent a certain selection of performances or a specific genre of music. They can also be associated with a set of different type of content, for example video content of interviews of a particular person or cartoons starring the same characters, and the like. The solution further specifies that several tokens, or other types of commands, could be used in a sequence to combine different attributes in the search. For example one could retrieve musical performances by Simon and Garfunkel of compositions by Paul Simon through presenting the two tokens in a sequence. The practical act of associating content to certain tokens can be done by simply selecting a collection of content using the user interface of the storage system, for example a database on a personal computer, and presenting the token to the reader, and requesting that the association be made in the computer memory. The association may be requested to be made with a set of content without specifying any particular order the content will be presented, or the user of the method can specify exactly in which sequence the content elements will be presented, or the selection may be a combination of the two methods. If no tokens exist at the time of the selection, the user can select the content elements and then produce the tokens.

The disclosed techniques overcome prior problems by providing end users an efficient, easy to use, aesthetically pleasing and intuitive method and system for accessing audio, video or other digital content. The disclosed method presents a physical item that has an image or shape that in the user's mind can be associated with the content and that has an identifying characteristic that enables an automatic system to identify it and make the content available and present it to the user. The method may provide for performing the act of selecting content from a location that is convenient and appropriate for its presentation. For example, the selection may take place in a living room or family room of a home while the content is accessed from or by a device that may be located at the home office, like a PC or even in the basement as a general purpose internet gateway, or in a set top box associated with a cable TV connection and a television set.

The disclosed technique may associate several elements of content with a single physical item that acts as a selection token. The user first selects a number of content elements that he or she wishes to be rendered in response to presenting a single token. The selection could be done for example by pointing (and/or clicking) at the desired content elements (for example music performances) at a computer screen utilizing a program that stores and organizes such content elements in a computer system. Once the selection has been completed, the user would present the token to be associated with the selected collection of content to the reader device that can read the identification of the token, and issue a command to the system to create the association. The selection of pieces of content for the content collection can also be done by sequentially presenting the tokens that are associated with each piece of content to the system and separately presenting a token to be associated with the collection and issuing a command to the system to make the association. Practical uses of this method would include selecting a set of content that is appropriate for a certain occasion, for example background music for a romantic dinner, or dance music of a particular type, and then associating it to one appropriately identifiable token to summon the collection to be presented.

There are several alternatives regarding where the different pieces of data are stored in the system. One possibility is to store all the associations in the back end of the system in a database. Another possibility is to store all of the data about the content and the associations in the memory of the token elements. Either the bar code, the RFID code, or another type of code could be universally identifying the content piece. The code could be printed on when the token is created, or it could be stored on the memory of a read/write capable RFID tag, in which case the system can change the information stored in the tag every time the tag is presented to the reader device.

Referring now to the figures, in accordance with the preferred embodiment, RFID or bar code technologies may be used for both the individual tags themselves and the tag readers, data networking capabilities and audio, video or other digital file storage software and/or interfaces with systems that can render the content, for example home entertainment systems.

If RFID tags are used, the tags may be embedded in or attached to a special substrate which could be, for example, roughly the size of a business card. It will contain images, logos or artwork associated with an audio, video or other digital file. This could be similar to traditional album covers or silk screened logos common on the CDs themselves. The housing can be comprised of a sturdy, water proof material such as laminated plastics. In the case of a bar code, the tags could be simple printed cards. In addition to the artwork associated with the content, the cards may also have on either side of the card a bar code that contains the identifying information for the content. In either case, the images on the items can be selected and printed by the end users of the content selection method and system.

The tags may be created by a computer system which retrieves the relevant information about a particular piece of content, for example a music performance, including images of the album cover when appropriate, and prints the images for the physical objects that will be used as the selection tokens according to the method described above. There are systems on the market that can automatically identify a music performance based on recognizing its digital file. There are also systems that provide the meta data (album cover, liner notes and artist information) of a large selection of performances over the internet. Such services may be used to get the meta data and to include the information on the printed cards that act as the tokens for accessing the corresponding audio content.

The reader of the automatically recognizable code could be an RFID tag reader such as the ones available from Omron corporation of Texas Instruments. The reader can also be a standard bar code reader such as the ones available from Symbol and others. The reader could also be a bar code wand, or pen reader, which is passed over the bar code of the tag. If such a device will be used, then one physical token can have several bar codes printed on it and the end user can select which ID's are recognized by swiping the pen reader over the desired codes. In one variation, the token can be the original CD packaging that may have been purchased from a music store and the code can be the bar code that was printed on the packaging or cover by the producer of the CD.

The transmitters and the receivers in the preferred embodiment can be standard data network devices, for example, a Bluetooth wireless personal area network, a 802.1 lb wireless local area network, an Ethernet network interface device, or similar data networking devices, either wired, or wireless. The transmitter can also use infrared radiation based technologies. For example the detector could transmit the detected token ID first to a unit at the entertainment center using standard IR technologies, such as the ones used in common remote controllers. This unit could be the same as the unit that is used for receiving the digital content signal and translating it to an input signal to the entertainment system. The same unit could then use a RF based communication to send the detected code or a request for specific content to the unit that stores the content or accesses it from the storage.

The event handling system can be any system that is capable of recognizing the receipt of a signal that a certain ID has been recognized and initiate the action associated with that ID, for example, retrieving a certain data file from a database system and transmitting the data to a receiver.

The event handling system disclosed in Appendix A is incorporate in whole in this specification.

The digital content file delivery system can be a standard file transfer utility or an audio or video streaming system, such as the ones available from Real Audio or Microsoft, Inc.

The interface to a player or rendering device can be a simple transformer that converts the digital content file format to a format that is suitable for a rendering device or a player system, for example, a conversion from a streamed digital audio file to standard analog input signals for a home stereo system.

End users of said solution will have their audio, video or other digital file collections immediately accessible throughout their locations by simply waving the appropriate tag in front of the tag reader. The solution increases the overall utility of large capacity audio, video or other digital storage mediums by allowing the end user the flexibility and convenience of being able to summon any piece of content by simply browsing through their collection of tag cards. For example, the solution builds upon a person's mnemonic capacity to remember an image or logo associated with a particular piece of music. Instead of having to search through a long list of albums stored on a PC or worse remembering what slot the CD is stored in their large capacity CD player, the end user simply leafs through a collection of tags. They see the image or logo that reminds them of an album, select it and wave it in front of the RF tag reader, and the music is cued instantly.

There are efficiencies that can be gained by utilizing a visual clue that immediately accesses specific content, obviating the need for physical interfacing with the system. Users of this solution will benefit by being able to access the content from almost anywhere in a space where an RFID tag reader is placed. This will create a more aesthetically pleasing, comfortable environment in which accessing audio, video or other digital content becomes faster and easier. Entertainment systems can be kept out of site if desired, with the only visible components being the speakers and the RF readers. Users will have small collections of tags that can be carried on the person, or conveniently placed throughout a space in close proximity to an RF reader for access to the content.

The Tabula Rasa Component Framework (TRCF) disclosed in Appendix A, which is fully incorporated in this specification, may be used for implementing portions of the methods and systems disclosed herein.

Having now described the invention in accordance with the requirements of the patent statutes, those skilled in this art will understand how to make changes and modifications in the present invention to meet their specific requirements or conditions. Such changes and modifications may be made without departing from the scope and spirit of the invention as set forth in the following claims.

What is claimed is:

1. A method of accessing digital content comprising:
making available to a user a token having a characteristic recognizable by a user as associated with the digital content, said token including a machine readable characteristic; and
automatically presenting the digital content to the user in response to the user's selection of the token.

2. The method of claim 1 wherein the token characteristic is an image or shape.

3. The method of claim 1 wherein the digital content resides on a server device.

4. The method of claim 1 wherein the digital content is audio or video content.

5. The method of claim 1 wherein the digital content resides, or is primarily accessed by, a device that is not located where the digital content is presented.

6. A method of accessing digital audio content over a wireless network comprising:
making available a token having an image representing the performer(s) and a particular performance of specific digital content and including a machine readable code;
automatically identifying the code in response to a user's selection of the token;
transmitting a digital stream over a wireless local area network, the digital stream includes the specific digital content corresponding to the token;
receiving the digital stream;
converting the digital stream to a standard audio input signal; and
performing the digital audio on a local entertainment center.
